(19) United States
(12) Patent Application Publication
(10) Pub. No.: US 2004/0217554 A1
(43) Pub. Date: Nov. 4, 2004

(54) Sealing bellows for a ball and joint

(76) Inventor: Olaf Abels, Belm (DE)

Correspondence Address: McGlew & Tuttle, Scarborough Station, Scarborough, NY, 10510-0827, US

(21) Appl. No.: 10/482,236

(22) PCT Filed: Feb. 18, 2003
(86) PCT No.: PCT/DE03/00494

(30) Foreign Application Priority Data
Jun. 3, 2002 (DE) 102-09-725.9

(51) Int. Cl. F16J 15/52

(52) U.S. Cl. 277/634

(57) ABSTRACT

An elastic sealing bellows for a ball and socket joint, preferably for chassis suspensions or steering mechanisms of motor vehicles is presented, in which the ball and socket joint has a joint housing with a pivot pin, which is mounted therein rotatably and pivotably and is fixed therein with a corresponding pin part at a chassis-side mount. The sealing bellows (1) is fixed statically at the joint housing and by a sealing seat (8) having a sealing lip (7), which surrounds the pin part (4), and is arranged at a sealing bellows flange and bulges forward toward the pin part (4) in a bead-like manner. The internal diameter (d) surrounding the pin part (4) is selected to be smaller than the external diameter (D) of the corresponding area of the pin part. A pushing spring system has a pushing force generated by the deformation of the sealing lip (7) and provides a sufficient pressing force to achieve a durable sealing action of the sealing seat (8). The pushing spring system is created in the area of the sealing bellows flange (5), which is that directly adjacent to the sealing lip (7) in the axial longitudinal direction of the axis (10) of the pivot pin. The sealing bellows flange (5) has a reinforcing ring (11) formed of a nonelastic material and arranged at a short free distance (9) from the pin part (4) in the assembled state of the ball and socket joint and surrounds the pin part. The pushing spring system can be calculated with only a few parameters in a simple manner and can be manufactured in a simple manner.

### FIELD OF THE INVENTION

The present invention pertains to an elastic sealing bellows for a ball and socket joint preferably for chassis suspensions or steering mechanisms of motor vehicles, in which the ball and socket joint has a joint housing with a pivot pin, which is mounted rotatably and pivotably therein and is fixed with a corresponding pin part to a chassis-side mount, wherein the sealing bellows is fixed statically at the joint housing and at the pin part by means of a sealing seat comprising at least one sealing lip, which surrounds the pin part, is arranged at a sealing bellows flange and bulges forward in a bead-like manner toward the pin part, and whose internal diameter surrounding the pin part is smaller than the external diameter of the corresponding pin part area.

### BACKGROUND OF THE INVENTION

Elastic sealing bellows for ball and socket joints are used, in general, to protect the inner area of the joint housing of such a ball and socket joint from environmental effects such as water and contaminants. The joint housing of such a ball and socket joint usually accommodates a pivot pin in a joint shell. Various sealing systems have been known from the state of the art for the sealing action of ball and socket joints; these are usually based on the build-up of a compressive stress, which keeps the sealing bellows flange in contact with the pin part during movements of the pin part, in the area of the sealing bellows flange, in which the sealing seat is formed between the sealing bellows and the pin part. This is achieved in simple systems by the fact that a compressive stress is built up due to the widening of the sealing bellows flange with the forward-bulging sealing lip due to the elastic properties of the material of the sealing bellows. The compressive stress may be optionally supported by generating a centripetal prestress on the outer side of the sealing bellows flange by means of additionally attached spring elements, e.g., in the form of straining rings.

Another possibility of increasing the pressing forces of the rubber bellows flange on the pin part is to incorporate additional shaped elements by vulcanization in the area of the sealing bellows flange, in which case the volume of the elastic material of the sealing bellows, which volume is located between the shaped elements and the sealing seat at the surface of the pin part, will be squeezed during the widening of the internal diameter of the sealing bellows flange and increased surface pressure will be generated at the sealing seat.

The described possibilities of generating a compressive stress at the sealing seat, which are known from the state of the art, have, on the whole, drawbacks concerning the possibility of metering the surface pressure as well as the sensitivity of the sealing system to tolerances. For example, tolerances from manufacturing and assembly processes add up in the above-described straining ring designs.

Sealing solutions in which shaped elements incorporated by vulcanization are used are inherently more complicated in terms of the manufacturing process involved than the other sealing variants described, and, moreover, their function is also extremely dependent on manufacturing tolerances, especially because of the mostly very small volume of rubber, which is subjected to compressive stress between the shaped elements and the surface of the pin part.

The above-described variants, in which sealing bellows are used without additional tensioning elements, have proved successful in practice only up to a certain angular deflection of the ball and socket joint. This limitation is because a greater angular deflection of the pin part inherently also entails a greater movement of the rest of the jacket surface of the sealing bellows, which in turn gives rise to forces because of the properties of the material which may lead to jamming of the sealing bellows flange and consequently to a considerable reduction of the sealing action due to a reduction in the size of the area of the sealing seat.

### SUMMARY OF THE INVENTION

The object of the present invention is therefore to provide an elastic sealing bellows of this type, which was described in the introduction, which eliminates the drawbacks known from the state of the art and guarantees reliable contact of the sealing bellows flange with the corresponding pin part under all prevailing conditions despite great angular deflections of the pin part. Moreover, the elastic sealing bellows according to the present invention shall be able to be manufactured at low cost, and, in particular, low tolerance sensitivity within the framework of the manufacturing process is significant for the sealing bellows itself.

This object is accomplished according to the present invention by the sealing bellows flange having a reinforcing ring, which is made of a nonelastic material, is arranged directly adjacent to the sealing seat in the axial longitudinal direction of the pivot pin and surrounds the pin part.

Contrary to the above-described solutions known from the state of the art, this design according to the present invention generates shearing forces within the sealing bellows flange, and, contrary to the compressive forces usually applied, these shearing forces meet substantially higher requirements in terms of their robustness and tolerance insensitivity. The shearing forces are based on the fact that the sealing lip, bulged inwardly, is widened during the mounting of the bellows on the pin part. At the same time, a pushing spring action, which provides the necessary pressing forces in the area of the sealing seat, is generated by the reinforcing ring, which is arranged directly adjacent to the sealing seat and completely surrounds the pin part.

The peculiarity of the generation of the pressing force is that no rubber volume is squeezed between the reinforcing ring and the pin part, but the necessary pressing force is applied only via the axial load prevailing around the rubber volume next to the reinforcing ring.

The magnitude of the shearing forces occurring can be increased especially by the reinforcing ring having a rectangular cross section, with the shorter of the sides of the cross section being arranged pointing toward the pin part.

If, moreover, the longitudinal extension of the longer side of the rectangular cross section of the reinforcing ring is essentially exactly as great as the overall width of the sealing bellows flange on its circumferential cross section, an optimal shearing force yield will develop in the area of the sealing seat.

Moreover, it proved to be advantageous for the manufacturing process for the sealing bellows to consist of a rubber material, in which the reinforcing ring is incorporated by vulcanization in the area of the sealing bellows flange. The incorporation by vulcanization of a metallic reinforcing ring can be carried out in a technologically simple manner, and a robust connected system comprising the sealing bellows flange and the reinforcing ring is formed, and the shaping of the sealing bellows flange as an injection molded part entails no special restrictions in terms of design.

Provisions are made in another advantageous embodiment for the free distance between the reinforcing ring and the pin part to be selected in the range of 0.5 mm to 2.0 mm. Especially in the case of great deflections of the pivot pin, which in turn implies corresponding forces in the jacket surface due to the deformation of the sealing bellows, this measure causes these forces to be able to be absorbed for the most part by the supporting action of the reinforcing ring against the area of the pin part located opposite the reinforcing ring.

The shearing stresses can be increased, besides by the fact that the reinforcing ring has a rectangular cross-sectional shape, by the difference of the diameters of the sealing lip projecting in the direction of the pivot part and the pin area at which the sealing lip is in contact after the mounting being substantially greater than the difference between the internal dimension of the reinforcing ring and the external diameter of the area of the pin part that is located opposite the reinforcing ring.

The combination of the measures described leads to reliable support in the case of greater deflections of the pivot pin and at the same time implies a reliable sealing action, which can offer its good function even over a long life of the joint due to the strong deformation forces in the area of the sealing lips, which generate the strong shearing forces described within the adjacent sealing bellows flange. Moreover, the described design according to the present invention has the advantage that the distribution of the prestress is uniform over the entire circumference, unlike in the case of, e.g., straining rings, because the reinforcing ring has no pressure-free intermediate space, contrary to straining rings. The wear and settling behavior of the sealing bellows can, furthermore, be reduced to the necessary minimum by reducing the prestress of the sealing seat, because the forces occurring are determined by substantially fewer parameters than in conventional sealing bellows systems. It shall be borne in mind in this connection that the dimensioning of the prestress in the area of the sealing bellows flange is always determined by the lowest residual surface pressure over the circumference during the pivoting of the pivot pin. It was ultimately found that the determination of the general parameters can be calculated for a correct functioning so reliably that different applications can be taken into account with a substantially smaller amount of testing during the design of the elastic sealing bellows according to the present invention.

An exemplary embodiment of the subject of the present invention will be explained in greater detail below on the basis of the attached drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

FIG. 1 is an enlarged sectional view of a detail of an elastic sealing bellows of the type according to the present invention in the area of the sealing bellows flange before installation in a ball and socket joint, and

FIG. 2 is an enlarged sectional view of a detail of the sealing bellows from FIG. 1 after the assembly of the ball and socket joint, which is carried out by pulling over the pivot pin.

### DESCRIPTION OF THE PREFERRED EMBODIMENT

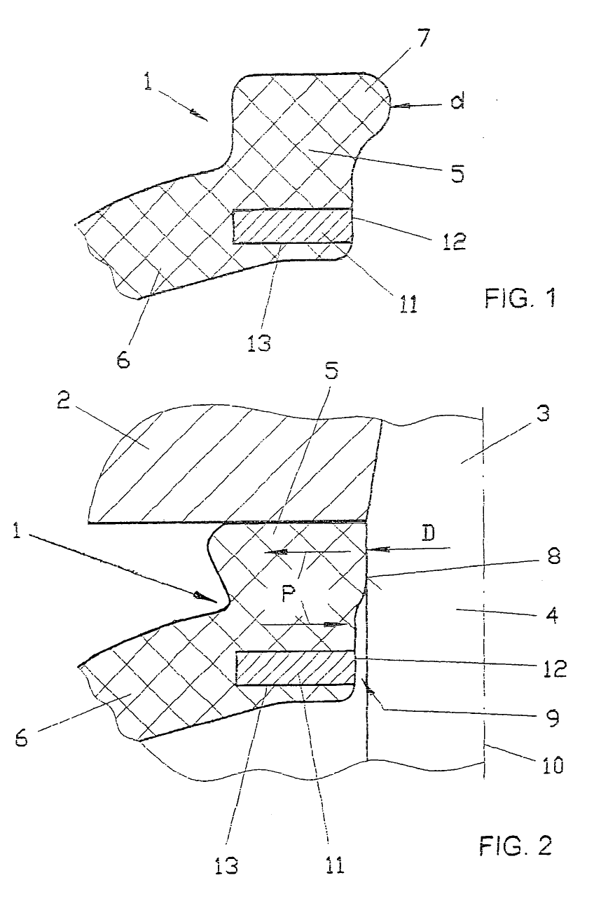

Referring to the drawings in particular, only a section of the sealing bellows designated as a whole by 1 is shown in FIG. 1. The sealing bellows flange 5, which joins a jacket surface 6 of the sealing bellows 1, and which is decisive for the formation of a sealing seat, is essential for the design according to the present invention. The fixed connection between the sealing bellows 1 and the joint housing, which connection is located at the opposite end of the jacket surface 6, is designed in the manner known from the state of the art and is irrelevant for the idea of the invention.

In the area of the sealing bellows flange 5, the flange has a sealing lip 7, which is arranged at its free upper end and has an essentially semicircular cross section. The area of the sealing lip 7 is joined, directly adjacent, by a reinforcing ring 11 integrated in the sealing bellows flange 5. Contrary to the elastic material of the sealing bellows 1, the reinforcing ring is made of a nonelastic or slightly elastic material, preferably metal. The reinforcing ring 11 is incorporated in the sealing bellows flange 5 by vulcanization and has a rectangular cross section.

As is apparent from FIG. 1, the shorter of the sides 12 of the cross section is arranged pointing toward the inner side of the sealing bellows 1, which said inner side is provided with the sealing lip 7 bulging forward. The second, longer side 13 of the rectangular cross section corresponds essentially to the overall width of the sealing bellows flange 5 at its circumferential cross section.

The specific design of the sealing bellows flange with the sealing lip 7 bulging forward and with the reinforcing ring 11 arranged next to it forms a so-called pushing spring system, which generates shearing forces in the corresponding area of the sealing bellows flange after the assembly of the sealing bellows with the pin part 4 of a pivot pin 3 due to the deformation of the sealing lip 7. The deformation of the sealing lip, which arises from the assembled state, can be clearly recognized in FIG. 2. The shearing forces acting within the sealing bellows flange are indicated by arrows P for illustration in FIG. 2. The view in FIG. 2 shows the sealing bellows 1 pulled over the pin part 4 of a pivot pin 3, which is accommodated in a joint housing 2 of a ball and socket joint in a manner not specifically shown here. It can be clearly recognized from the view that the sealing lip 7, which markedly bulges forward in FIG. 1, has been compressed by the pin part 4.

The shearing forces P, which are indicated by the arrows, are generated within the sealing bellows flange 5 due to these prevailing conditions, because the deformation of the sealing bellows flange 5 as a whole is stopped by the reinforcing ring 11 incorporated by vulcanization. The internal diameter of the reinforcing ring 11 is selected to be such that a slight distance 9 is left after the assembly between the side 12 of the cross section of the reinforcing ring 11 and the surface of the pin part 4. The distance 9 tapers toward the free end of the sealing bellows flange 5 and passes over into the sealing seat 8 proper, which is essential for the function of the sealing bellows 1.

The design of a so-called pushing spring system, comprising the sealing lip 7 and the reinforcing ring 11, arises essentially from the fact that the reinforcing ring 11 with its rectangular cross section is arranged directly adjacent when viewed in the axial longitudinal direction of the axis 10 of the pivot pin. The shape of the sealing lip 7 and here especially the height of the bulge, i.e., the internal diameter d of the sealing lip in relation to the external diameter D, i.e., the difference between them, represent the essential calculated variables for the pressing forces available in the area of the sealing seat 8, besides the dimensions of the rectangle of the reinforcing ring 11. The distance 9 between the reinforcing ring 11 and the external diameter Dof the pin part 4 is advantageously substantially smaller than the difference between the diameters Dand the d. Forces generated within the jacket surface 6 during a deflection of the pivot pin 3 can thus be absorbed by the contact of the side 12 of the cross section of the reinforcing ring 11 with the corresponding pin area of the pin part 4.

A pushing spring system is thus formed, which depends on a small number of general parameters only and which makes possible an optimal sealing action over a long service life of the ball and socket joint provided with the elastic sealing bellows according to the present invention due to a much simpler calculation than prior-art sealing systems for ball and socket joints. At the same time, the sealing bellows can be manufactured in a simple manner and at a low cost, and the incorporation of the reinforcing ring 11 by vulcanization allows the otherwise independent design of the sealing bellows flange 5 with its sealing lip 7 arranged at it.

While a specific embodiment of the invention has been shown and described in detail to illustrate the application of the principles of the invention, it will be understood that the invention may be embodied otherwise without departing from such principles.

1-7 (Canceled)

8. An elastic sealing bellows for a ball and socket joint having a housing and a pivot pin mounted rotatably and pivotably in the housing and fixed with a corresponding pin part at a vehicle-side mount, the sealing bellows comprising:
a sealing seat fixing the sealing bellows statically at a joint housing and having a sealing lip surrounding the pin part;
a sealing bellows flange, said sealing seat being arranged at said sealing bellows flange with said sealing lip bulging forward toward the pin part in a bead-like manner, said sealing lip having an internal diameter surrounding the pin part that is smaller than the external diameter of the corresponding pin part area; and
a reinforcing ring directly adjacent to the axis of the pivot pin in a axial longitudinal direction, said reinforcing ring being made of a nonelastic material and being arranged at a short free distance from the pin part in an assembled state and surrounding the pin part.

9. An elastic sealing bellows in accordance with claim 8, wherein said reinforcing ring has a rectangular cross section, wherein a shorter of the sides of the cross section is arranged pointing toward the pin part.

10. An elastic sealing bellows in accordance with claim 9, wherein the longitudinal extension of the longer side of the rectangular cross section of the reinforcing ring essentially corresponds to the overall width of the sealing bellows flange at its circumferential cross section.

11. An elastic sealing bellows in accordance with claim 8, wherein the sealing bellows is formed of a rubber material, in which the reinforcing ring is incorporated by vulcanization in the area of the sealing bellows flange.

12. An elastic sealing bellows in accordance with claim 8, wherein the free distance between the reinforcing ring and the pin part is in the range of 0.5 mm to 2.0 mm.

13. An elastic sealing bellows in accordance with claim 8, wherein the sealing lip has a cross section bulging forward in the direction of the pin part in an essentially semicircular shape.

14. An elastic sealing bellows in accordance with claim 8, wherein the difference between the diameter dimensions of the sealing lip and the pin part is substantially greater than the difference between the internal dimension of the reinforcing ring and the external diameter of the pin part area located opposite the reinforcing ring.

15. A motor vehicle chassis suspension or steering mechanism ball and socket joint, comprising:
a housing;
a pivot pin mounted rotatably and pivotably in the housing and fixed with a corresponding pin part at a vehicle-side mount; and
a sealing bellows with a sealing bellows flange, a sealing seat fixing the sealing bellows statically at a joint housing and having a sealing lip surrounding the pin part, said sealing seat being arranged at said sealing bellows flange with said sealing lip bulging forward toward the pin part in a bead-like manner, said sealing lip having an internal diameter surrounding the pin part that is smaller than the external diameter of the corresponding pin part area and a reinforcing ring directly adjacent to the axis of the pivot pin in a axial longitudinal direction, said reinforcing ring being made of a nonelastic material and being arranged at a short free distance from the pin part in an assembled state and surrounding the pin part.

16. A motor vehicle chassis suspension or steering mechanism ball and socket joint in accordance with claim 15, wherein said reinforcing ring has a rectangular cross section, wherein a shorter of the sides of the cross section is arranged pointing toward the pin part.

17. A motor vehicle chassis suspension or steering mechanism ball and socket joint in accordance with claim 16, wherein the longitudinal extension of the longer side of the rectangular cross section of the reinforcing ring essentially corresponds to the overall width of the sealing bellows flange at its circumferential cross section.

18. A motor vehicle chassis suspension or steering mechanism ball and socket joint in accordance with claim 15, wherein the sealing bellows is formed of a rubber material, in which the reinforcing ring is incorporated by vulcanization in the area of the sealing bellows flange.

19. A motor vehicle chassis suspension or steering mechanism ball and socket joint in accordance with claim 15, wherein the free distance between the reinforcing ring and the pin part is in the range of 0.5 mm to 2.0 mm.

20. A motor vehicle chassis suspension or steering mechanism ball and socket joint in accordance with claim 15, wherein the sealing lip has a cross section bulging forward in the direction of the pin part in an essentially semicircular shape.

21. A motor vehicle chassis suspension or steering mechanism ball and socket joint in accordance with claims 15, wherein the difference between the diameter dimensions of the sealing lip and the pin part is substantially greater than the difference between the internal dimension of the reinforcing ring and the external diameter of the pin part area located opposite the reinforcing ring.
